(19) United States
(12) Patent Application Publication
(10) Pub. No.: US 2004/0244181 A1
(43) Pub. Date: Dec. 9, 2004

(54) Product manufacturing line

(76) Inventors: Yoshiharu Nakamura, Aichi (JP); Takeshi Sakamaki, Aichi (JP)

Correspondence Address: Douglas J Christensen, Patterson Thuente Skaar & Christensen, 4800 IDS Center, 80 South Eighth Street, Minneapolis, MN, 55402-2100, US

(21) Appl. No.: 10/483,535

(22) PCT Filed: Jul. 11, 2002
(86) PCT No.: PCT/JP02/07079

(30) Foreign Application Priority Data
Jul. 12, 2001 (JP) 2001-212298

(51) Int. Cl. B23P 21/00

(52) U.S. Cl. 29/563

(57) ABSTRACT

A product manufacturing line for manufacturing a product by incorporating a component in a semi-finished product may include a conveyor for conveying the semi-finished product and a preparation area in which necessary preparation for feeding the component is previously made. The preparation area is positioned in front of a worker facing the conveyor. Further, the preparation area has a component storage means for storing a desired number of components and a component feeding means for feeding the component to a position that the worker can take the component. Therefore, the worker can take out the component without turning around, since the worker can take out the component from his or her front side.

### TECHNICAL FIELD OF THE INVENTION

The present invention relates to a product manufacturing line for sequentially incorporating components into semi-finished products that are conveyed by a conveyor and/or for desirably processing the semi-finished products.

### BACKGROUND OF THE INVENTION

Such a product manufacturing line is taught, for example, by Japanese Laid-Open Patent Publication No. 6-270028. This product manufacturing line has a layout in which a working space is provided between the conveyor and a component storage portion such as a cart on which components to be incorporated are stocked. Therefore, a worker is positioned between the conveyor and the component storage portion. As a result, when the worker faces the conveyor, the component storage portion is positioned behind him or her.

Thus, the worker has to turn around toward the component storage portion in order to take required components from the component storage portion. This may lead to poor working efficiency of component incorporating work.

### DISCLOSURE OF THE INVENTION

It is, accordingly, one object of the present invention to improve the conventional product manufacturing line in order to increase the working efficiency of component incorporating work.

In the present invention, a product manufacturing line for manufacturing a product by incorporating a component in a semi-finished product may include a conveyor for conveying the semi-finished product and a preparation area in which the necessary preparation for feeding the component has been previously made. The preparation area is positioned in front of a worker facing the conveyor. Further, the preparation area has a component storage means for storing a desired number of components, and a component feeding means for feeding the component to a position where the worker can take it.

According to the present invention, when the worker works to incorporate the component into the semi-finished products on the conveyor, he faces the preparation area. Therefore, there is no need for the worker to turn around. Consequently, his or her working efficiency is increased.

It should be noted that, in the present invention, the term “area in front of the worker” means a wide area exclusive of an area just behind the worker. That is, the term “area in front of the worker” includes not only a full frontal area of the worker but also obliquely frontal areas and side areas of the worker.

In addition, the term “semi-finished product” must be interpreted as a relative concept. Therefore, a completed product in one product manufacturing line can be regarded as a semi-finished product in another product manufacturing line.

According to another aspect of the present invention, the component storage means may be disposed across the conveyer from the worker.

According still another aspect of the invention, the product manufacturing line may include a plurality of lines and the adjacent lines have a common working space that is formed between their conveyors.

According to yet another aspect of the invention, the product manufacturing line may include a plurality of lines and the adjacent lines respectively have preparation areas that are formed between their conveyors. Further, the preparation areas have a common component supply path through which the components are supplied from the outside.

According to yet another aspect of the invention, the product manufacturing line may include a plurality of lines and the adjacent lines respectively have preparation areas that are formed between their conveyors. Further, these preparation areas respectively have component storage means that are oppositely disposed to each other. These separation areas have a common component supply path through which the components are supplied from the outside, and which is formed between the component storage means.

According to a further aspect of the invention, the component feeding means may have a means for changing the position of the component storage means at a predetermined component feeding position. Further, the component feeding means may have a component moving means for moving the components within the component storage means at a predetermined component feeding position. Further, the component feeding means may preferably be constructed so as to move in synchronism with the conveyor.

Other objects, and advantages, of the present invention will be readily understood from the following description of the preferred embodiments of the invention with reference to the accompanying drawings.

### BRIEF DESCRIPTION OF THE DRAWINGS

FIG. 1 is a plan view of an automobile seat manufacturing line of the present invention.

FIG. 2 is a plan view of a seat pad assembling process.

FIG. 3 is a perspective view of a seat pad assembling process.

FIG. 4 is a side view of a seat pad assembling process.

FIG. 5 is a plan view of a headrest assembling process.

FIG. 6 is a perspective view of a headrest assembling process.

FIG. 7 is a sectional view taken along the line VII-VII of FIG. 5.

FIG. 8 is a plan view of a shield assembling process.

FIG. 9 is a perspective view of a shield assembling process.

FIG. 10 is a sectional view taken along the line X-X of FIG. 8.

FIG. 11 is a perspective view of a small-component assembling process.

FIG. 12 is a side view of a small-component assembling process.

FIG. 13 is a sectional view of a small-component assembling process, as seen from the preparation area.

### PREFERRED EMBODIMENTS OF THE INVENTION

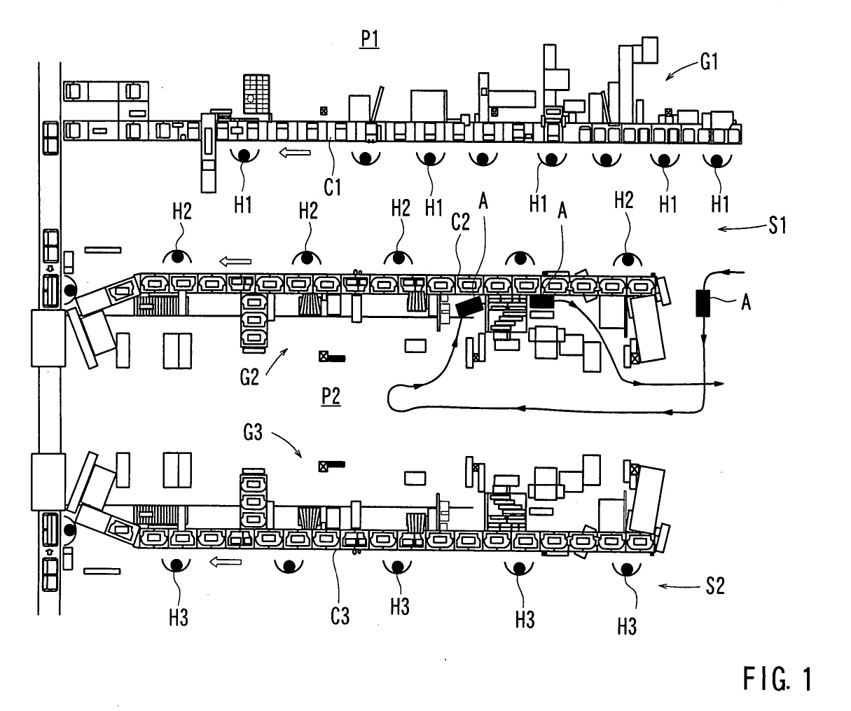

Hereinafter, an embodiment of the present invention will be described with reference to FIGS. 1 to 13. The product manufacturing line of this embodiment is an automobile seat manufacturing line.

As shown in FIG. 1, this manufacturing line includes three lines (first to third lines) that are arranged substantially in parallel with each other. These lines respectively have conveyors C1 to C3. Each of the conveyors C1 to C3 is arranged so as to run from the right to the left in the drawings. A common working space S1 is formed between the adjacent conveyors C1 and C2, so that workers H1 and H2 of the respective lines can work in the working space S1. Further, preparation areas G2 and G3 for the second and third lines are formed between the adjacent conveyors C2 and C3. Further, a preparation area G1 for the first line is formed on a side opposite to the workers H1 with respect to the conveyor C1. Further, a working space S2 is formed on a side opposite to the preparation area G3 with respect to the conveyor C3, so that the workers H3 of the third line can work therein. As is apparent from the above description, the preparation areas G1, G2, and G3, are respectively positioned in front of the workers H1, H2, and H3.

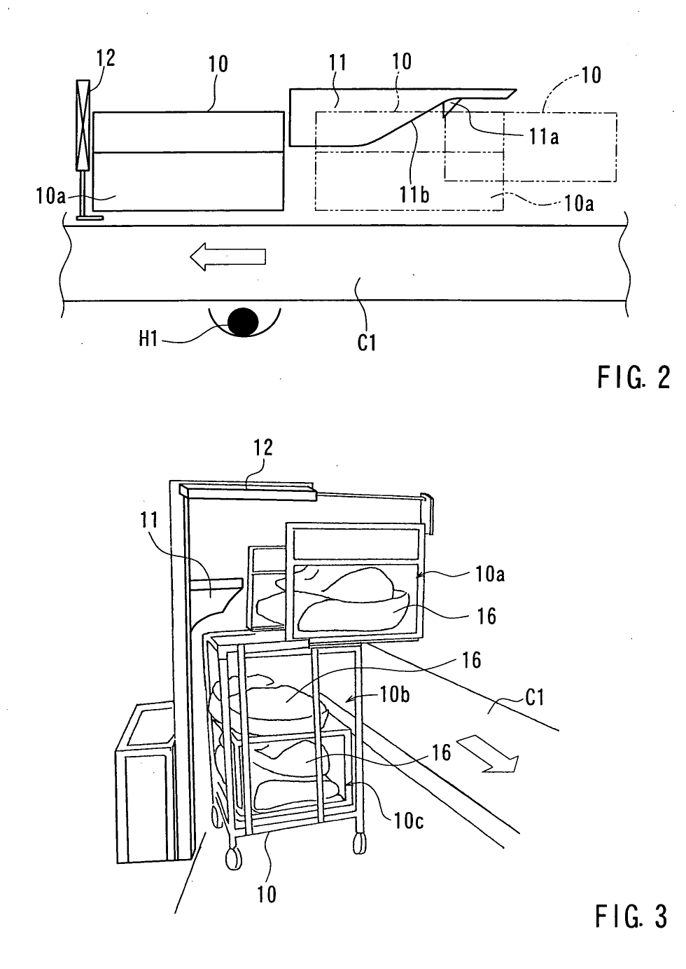

Each of the preparation areas G1 to G3 are respectively provided with a component storage means for storing components to be used in each of the operation processes of the individual lines and a component feeding means for feeding the components to positions accessible to the workers. The component storage means and the component feeding means will be described below with reference to FIGS. 2 to 13. Generally speaking, the component storage means comprise carts on which required components are stored. A component supply path P1 is formed behind the component storage means of the preparation area G1, so that the components can be supplied from outside of the manufacturing line. Further, the component storage means of the preparation areas G2 and G3 are opposed to each other so that a common component supply path P2 is formed behind the component storage means of the preparation areas G2 and G3.

Supplying of the components is performed by unpacking cargoes carried into a manufacturing plant and loading the components therein onto the component shelves, cages, etc. of the carts. At this time, the components are arranged such that they can be supplied sequentially from the preparation areas G1 to G3 according to the kinds of products to be manufactured in the individual lines, that is, according to kinds of semi-finished products sequentially supplied to the conveyors C1 to C3. The carts loaded with the components are transported to the respective preparation areas G1 to G3. Generally speaking, an automatic carriage is used for this cart transport.

As shown in FIG. 1, an automatic carriage A for supplying the components to the preparation area G2 travels along a predetermined traveling route indicated, for example, by the arrows. This automatic carriage A travels automatically while pulling the cart in order to supply the components to the desired component storage means in the preparation area G2. When the automatic carriage A reaches the target component storage means it places the cart (the cart loaded with the components thereon) at a predetermined position and returns to a component loading place after receiving an empty cart.

Next, some of the component storage means and the component feeding means will be described specifically with reference to FIGS. 2 to 13. Herein exemplified is the preparation area G1 of the first line corresponding to the conveyor C1, i.e., the front seat manufacturing line.

This first line includes a seat pad assembling process as shown in FIGS. 2 to 4. A cart 10 in this process is equipped with cages 10a to 10c in three stages. Each of the cages 10a to 10c contains a seat pad 16 (the components to be incorporated). The middle-stage cage 10b of the cages 10a to 10c is positioned at substantially the same height as the conveyor C1. Therefore, the worker H1 can easily take out the seat pad 16 therein simply by reaching out his arm.

However, regarding the upper-stage cage 10a and the lower-stage cage 10c, it is difficult for the worker H1 to take out the seat pads 16 therein solely by reaching out his arm. Therefore, the upper-stage cage 10a is designed such that it automatically moves over the conveyor C1 toward the worker H1 when the carriage 10 reaches a predetermined component feeding position (FIG. 3). That is, as shown in FIG. 2, when a cart 10 is brought in from the right side, locking engagement between the cart 10 and the upper-stage cage 10a is disengaged by means of a disengaging claw 11a of a guide member 11 that is disposed in the preparation area G1. Thereafter, when the cart 10 moves further toward the component feeding position, the upper-stage cage 10a is pushed out as described above by an inclined surface 11b (i.e., pushing means) of the guide member 11.

As a result, the worker H1 can take the seat pad 16 out of the upper-stage cage 10a simply by reaching out his arm. When the seat pad 16 of the upper-stage cage 10a has been removed, the projected upper-stage cage 10a is restored to a former position by means of a cylinder 12 that is disposed in the preparation area G1. As a result of this restoring operation, the upper-stage cage 10a is again locked to the cart 10.

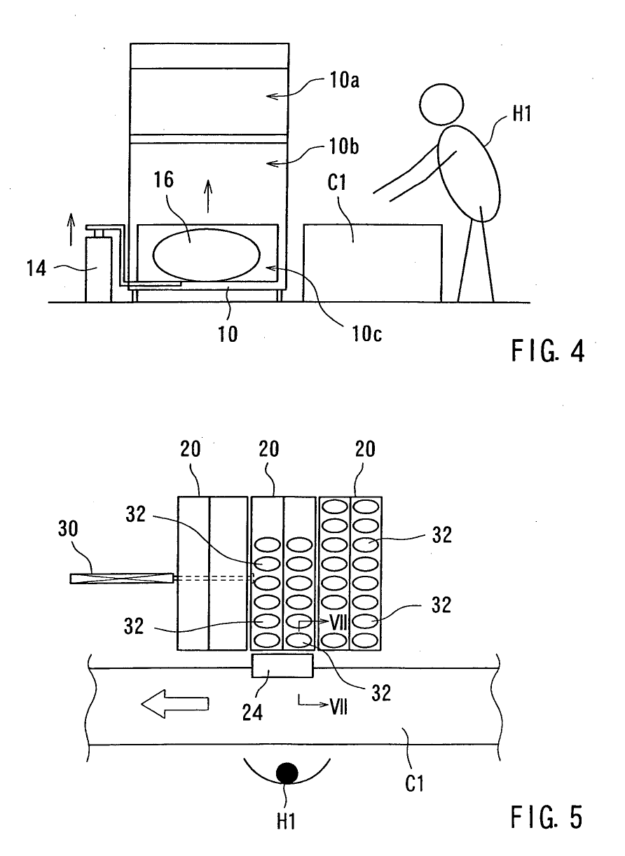

On the other hand, as shown in FIG. 4, the lower-stage cage 10c can be moved upward and downward with respect to the cart 10 by means of an elevator cylinder 14 (i.e., elevator means) that is provided in the preparation area G1. When the middle-stage cage 10b has become empty, the lower-stage cage 10c is raised to the position of the middle-stage cage 10b by means of the cylinder. As a result, the worker H1 can take out the seat pad 16 from the lower-stage cage 10c, as in the case of the middle-stage cage 10b.

Thus, in a portion of the preparation area G1 corresponding to the seat pad assembling process, the cages 10a to 10c of the cart 10 correspond to the component storage means. Further, the combination of the upper-stage cage 10a, the guide member 11, and the cylinder 12, and the combination of the lower-stage cage 10c and the elevator cylinder 14 correspond to the component feeding means.

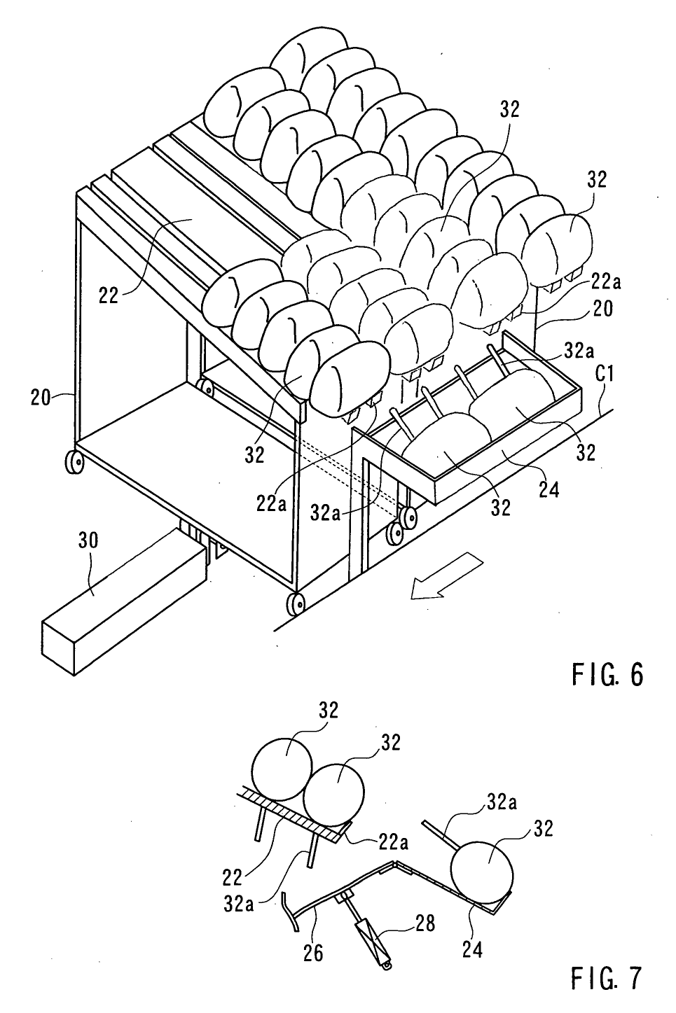

Further, the front seat manufacturing line (the first line) includes a headrest assembling process as shown in FIGS. 5 to 7. A cart 20 in this process is equipped with rails 22 inclined downwardly toward the conveyor C1. Headrests 32 (the components to be incorporated) for right and left front seats are disposed on the rails 22 and are arranged in two rows in a right and left paired up manner. The headrests 32 are arranged with their stays 32a inserted into the gaps formed between the rails 22, so as to be supplied sequentially toward the conveyor C1 without changing their posture due to inclination of the rails 22. Provided at end portions of the rails 22 that face the conveyor C1 are stoppers 22a for receiving the foremost headrests 32 (FIG. 7).

As shown in FIG. 5, in this process, three carts arranged along the conveyor C1 are used. FIG. 5 shows, in a left-to-light fashion, the empty cart 20 in which the headrests 32 have been used up, the cart 20 in which the headrests 32 are being supplied, and the waiting cart 20 which is fully loaded with the headrests 32. A drawing cylinder 30 is disposed in the preparation area G1, so that the empty cart 20 is taken away from the component feeding position, and at the same time, the waiting cart 20 is brought to the component feeding position.

Further, a component receiving portion 24 is positioned at the component feeding position of the preparation area G1. The component receiving portion 24 is arranged between the cart 20 and the conveyor C1. The receiving portion 24 has a size that can receive a pair of headrests 32. As shown in FIG. 7, this receiving portion 24 is equipped with a lifting arm 26 (i.e., component moving means) that is actuated by a cylinder 28. When the lifting arm 26 is raised by the cylinder 28, the foremost pair of headrests 32 on the rails 22 are transferred to the receiving portion 24 beyond the stoppers 22a. As a result, the worker H1 can take out the headrests 32 from the receiving portion 24.

Generally speaking, the component receiving portion 24 is designed such that the worker H1 having the headrests 32 can smoothly incorporate them into a seat back (semi-finished product) on the conveyor C1 without changing the orientation of the stays 32a of the headrests 32.

In the portion of the preparation area G1 corresponding to the headrest assembling process, the rails 22 of the cart 20 correspond to the component storage means. The rails 22, the component receiving portion 24, and the lifting arm 26 correspond to the component feeding means.

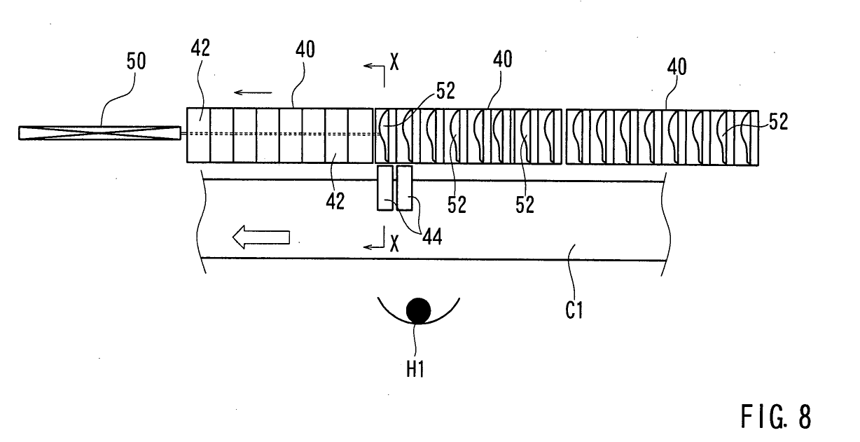

Further, the front seat manufacturing line (first line) includes a seat shield assembling process as shown in FIGS. 8 to 10. As shown in FIG. 8, the cart 40 in this process is equipped with a plurality of accommodating spaces 42 that are disposed along the conveyor C1. As shown in FIG. 10, the accommodating spaces 42 are arranged in upper and lower stages. Components (i.e., shields 52) to be incorporated into both sides of the seat are received in these accommodating spaces 42. Generally speaking, the upper and lower stages of the accommodating spaces 42 respectively receive the right-side shields 52 and the left-side shields 52.

As shown in FIG. 8, in this process, three carts arranged along the side of the conveyor C1 are used. FIG. 8 shows, in a left-to-right fashion relative to the worker H1, an empty cart 40 in which the shields 52 have been used up, a cart 40 in which the shields 52 are being supplied, and a waiting cart 40 which is fully loaded with the shields 52. A drawing cylinder 50 is disposed in the preparation area G1, so that the carts 40 are intermittently moved in the running direction of the conveyor C1 as the shields 52 are supplied.

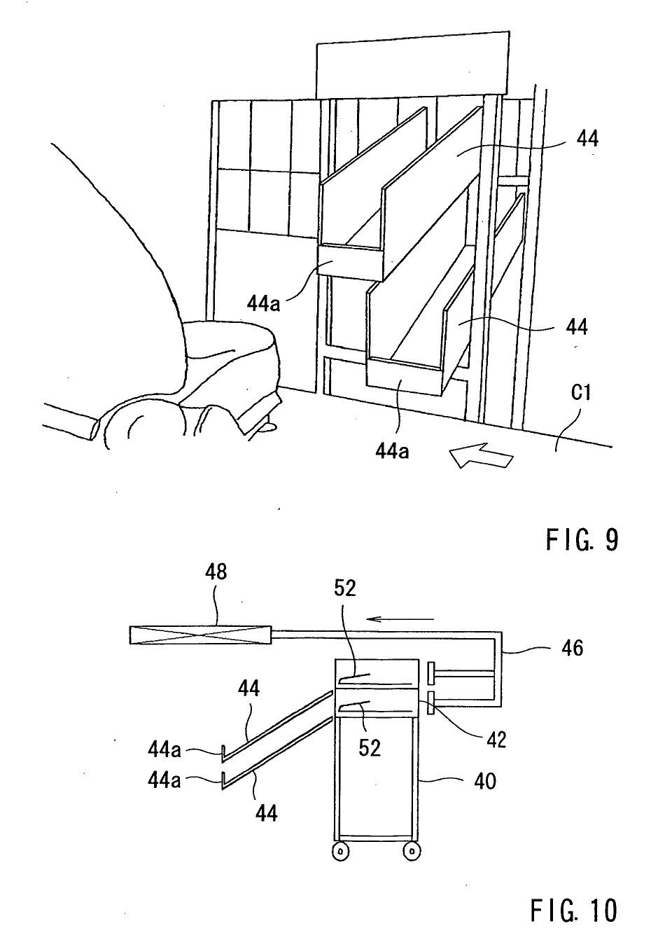

Further, a pair of upper and lower feeder gutters 44 (i.e., component moving means) are disposed in the component feeding position in the preparation area G1. The feeder gutters 44 are downwardly inclined toward the conveyor C1 and are horizontally offset from each other (FIGS. 9 and 10). These feeder gutters 44 are arranged, so as to respectively receive the shields 52 from the upper and lower stages of the accommodating spaces 42. Provided at a forward end portion of each feeder gutter 44 is a stopper 44a for receiving the shields 52.

As shown in FIG. 10, a push-out member 46 is disposed in the preparation area G1, so that the shields 52 can be sent out from the accommodating spaces 42 of the cart 40 positioned at the component feeding position to the feeder gutters 44. When this push-out member 46 is actuated by a cylinder 48, the shields 52 are pushed out of the upper and lower stages of the accommodating spaces 42 and are sent to the feeder gutters 44. As a result, the worker H1 can take out the shields 52 from both of the feeder gutters 44.

In the portion of the preparation area G1 corresponding to the seat shield assembling process, the accommodating spaces 42 of the cart 40 correspond to the component storage means. Further, the feeder gutters 44 and the push-out member 46 substantially correspond to the component feeding means.

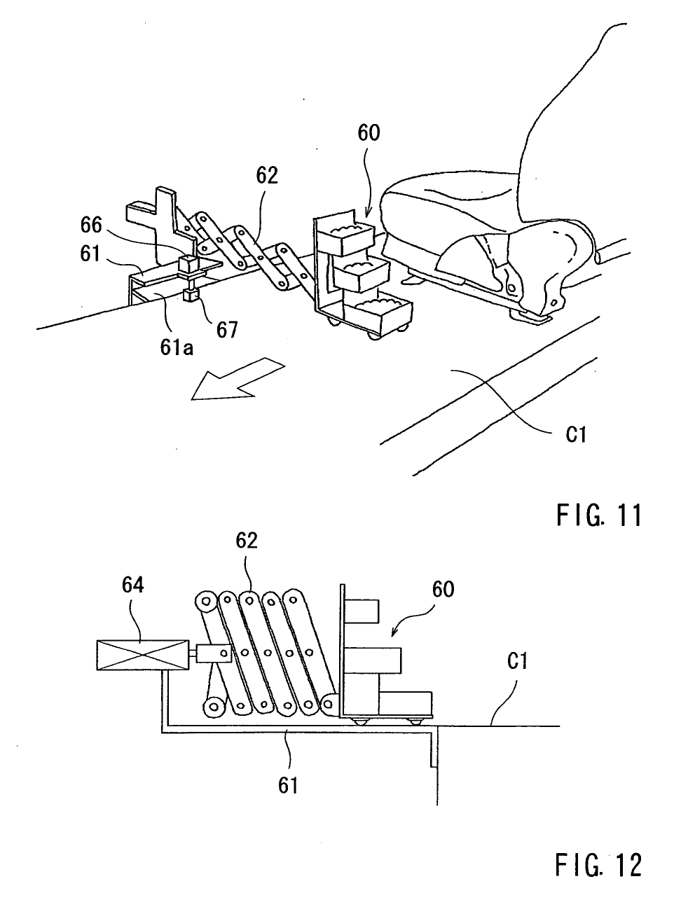

Further, the front seat manufacturing line (first line) includes a small-component assembling process as shown in FIGS. 11 to 13. In this process, a base 61 is used instead of the cart. Mounted to the base 61 is a pantograph-type extendable arm 62 (i.e., a pushing means). Accommodating boxes 60 are connected to a forward end of the extendable arm 62. The extendable arm 62 is connected to a cylinder 64 so as to be extendable.

Received in the accommodating boxes 60 are small components such as bolts, nuts, screws, clips, and resin plugs, which are separated according to the types of the small components. When the extendable arm 62 is extended by the cylinder 64, the accommodating boxes 60 are pushed out onto a transport surface of the conveyor C1. As a result, the worker H1 can take out the small components from the accommodating boxes 60.

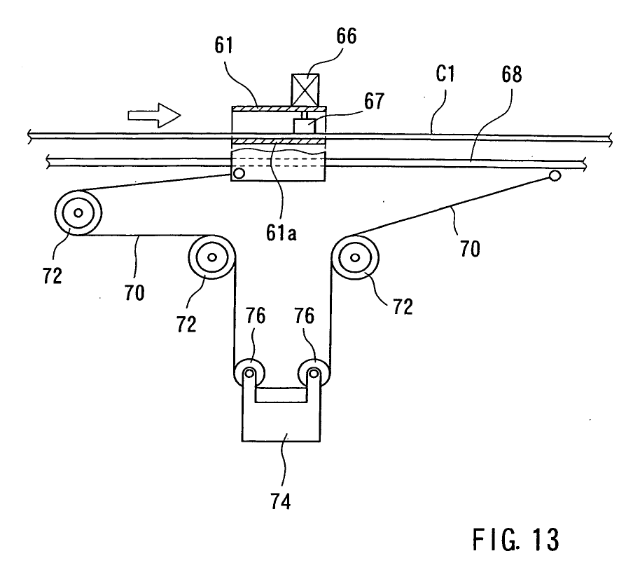

The base 61 is combined with a synchronously moving means so as to move within a predetermined range in synchronism with the movement of the conveyor C1. That is, as shown in FIG. 13 the base 61 is slidably mounted to a guide 68 extending along the conveyor C1. Further, the base 61 is equipped with a presser cylinder 66 that is situated on the upper surface of the conveyor C1 and a backing plate 61a that is situated on the lower surface of the conveyor C1. A block 67 is attached to the presser cylinder 66. When the presser cylinder 66 is actuated and the block 67 is downwardly pressed against the backing plate 61a with interleaving the conveyor C1, the conveyor C1 is clamped between the block 67 and the backing plate 61a so that the block 61 engages the conveyor C1. As a result, the base 61 is guided by the guide 68 together with the accommodating box 60, thereby moving in synchronism with the conveyor C1.

Further, as shown in FIG. 13, a plurality of pulleys 72 are arranged below the base 61. A single rope 70 is wrapped around these pulleys 72. One end of the rope is connected to the base 61 and the other end thereof is fixed to a predetermined fixture portion. Further, the rope 70 is provided with a weight 74, which is positioned between a pair of pulleys 72 and is suspended from of the rope 70 via movable pulleys 76. Therefore, when the base 61 moves in synchronism with the conveyor C1 as described above, the rope 70 is pulled up, and as a result, the weight 74 is raised. When the operation of the presser cylinder 66 is deactuated and the block 61 is disengaged from the conveyor C1, the weight 74 descends by its own weight, so that the base 61 is returned to an original position by the force of the weight 74.

In this small-component assembling process, the accommodating boxes 60 are pushed out onto the transport surface of the conveyor C1 by the extendable arm 62 so that the worker H1 can easily take out the small components from the accommodating boxes 60.

Further, since the base 61 and the accommodating boxes 61 move in synchronism with the conveyor C1 by means of the synchronous movement means thus constructed, the accommodating boxes 60 can always be maintained at a predetermined position with respect to the worker H1, even if for example, the small-component assembling operation is delayed. Therefore, there is no need for the worker H1 to go back in order to take out the small components. The worker's moving range is effectively reduced. As a result, the worker H1 can always perform the assembling operation in an optimum state.

In the portion of the preparation area G1 corresponding to the small-component assembling process, the accommodating boxes 60 correspond to the component storage means. Further, the accommodating box 60, the base 61, and the extendable arm 62 essentially correspond to the component feeding means. Thus, in this process both the component storage means and the component feeding means move in synchronism with the conveyor C1. However, it is also possible to construct an embodiment such that only the component feeding means moves in synchronism with the conveyor C1.

The component feeding means and the component storage means described above are samples and are not limited thereto. Therefore, in the present invention it is possible to use various other types of component feeding means and component storage means.

Further, in the present invention it is also possible to supply various tools for processing the semi-finished products instead of the components.

Further, it is also possible to supply the components or the tools from above the conveyors C1 to C3 instead of supplying from a front side of the workers H1 to H3.

Further, the component storage means and the component feeding means can be partially arranged in the working spaces S1 and S2, in order to comply with various circumstances such as limited space.

The present invention provides the following advantages.

Since the workers H1 to H3 working on the lines can take out the components from their front side, there is no need for them to turn around in order to take out the components. This may facilitate working as well as increase working efficiency.

Since the working spaces S1 and S2 do not have carts or stock shelves as the component storage means, the workers H1 to H3 can smoothly get in and out of the working spaces S1 and S2 as well as easily check working conditions.

Since the conveyors C1 and C2 have the common working space S1 formed therebetween, mutual support is possible for the workers H1 and H2 of the respective lines.

Since the preparation area G2 and G3 have the common component supply path P2 formed behind the component storage means thereof, it is possible to decrease the space occupied by a manufacturing line.

In the preparation areas G1 to G3, the components in the component storage means are arranged such that they are supplied in correspondence with the kinds of the semi-finished products transported by the conveyors. Further, the component feeding means is designed so as to supply the desired number of components that are required for a single assembling operation. Therefore, there is no need for the workers H1 to H3 to move around in order to select the components.

The preferred embodiment of the present invention is described in detail with reference to the drawings. However, this description should not be construed restrictively. Only the claims define the scope of the invention. Therefore, various changes and modifications are possible without departing from the spirit of the present invention.

1. A product manufacturing line for manufacturing a product by incorporating a component in a semi-finished product, the product manufacturing line includes a plurality of lines, the lines respectively comprising:
conveyors for conveying the semi-finished product, and
preparation areas in which the component is prepared for feeding to workers, and
working spaces for the workers, and
wherein the conveyer has a first side and a second side, the preparation area is disposed on one of the first and second sides, and the working space is disposed on the other of the first and second sides.

2. A product manufacturing line as defined in claim 1, wherein at least one set of two lines have the preparation areas disposed on facing sides of their respective conveyers, further comprising:
a component supply path that is located between the two preparation areas, and
component storage means that are respectively located in the two preparation areas.

3. A product manufacturing line as defined in claim 2, wherein the component feeding means has a means for changing the position of the component storage means at a predetermined component feeding position.

4. A product manufacturing line as defined in claim 3, wherein the means for changing the position of the component storage means comprises a pushing means.

5. A product manufacturing line as defined in claim 3, wherein the means for changing the position of the component storage means comprises an elevator means.

6. A product manufacturing line as defined in claim 2, wherein the component feeding means has a means for moving the component stored in the component storage means at a predetermined component feeding portion.

7. A product manufacturing line as defined in claim 6, wherein the means for moving the component comprises a lifting arm.

8. A product manufacturing line as defined in claim 6, wherein the means for moving the component comprises a feeder gutter.

9. A product manufacturing line as defined in claim 2, wherein the component feeding means has a synchronously moving means, so as to move in a synchronism with the conveyer.

10. Cancelled.

11. Cancelled.

12. Cancelled.

13. Cancelled.
